(19) United States
(12) Patent Application Publication
(10) Pub. No.: US 2014/0236731 A1
(43) Pub. Date: Aug. 21, 2014

(54) Using Interaction Data of Application Users to Target a Social-Networking Advertisement

(71) Applicant: ADOBE SYSTEMS INCORPORATED, San Jose, CA (US)

(72) Inventors: Andrew I. Schein, San Jose, CA (US); Abhishek Pani, San Francisco, CA (US)

(73) Assignee: ADOBE SYSTEMS INCORPORATED, San Jose, CA (US)

(21) Appl. No.: 13/772,982

(22) Filed: Feb. 21, 2013

(51) Int. Cl. G06Q 30/02; G06Q 50/00

(52) U.S. Cl. CPC G06Q 30/0269; G06Q 50/01
USPC 705/14.66

(57) ABSTRACT

Techniques for using interaction data of application users to target a social-networking advertisement are described herein, as well as other techniques. Interaction data of application users is received through applications associated with the social-networking platform. This interaction data can provide additional information about users to better enable marketers to target users of a social-networking platform. This improved targeting potentially saves advertising resources, increases effectiveness of advertisements, or improves users' impressions of a maker or brand associated with the advertisement.

### BACKGROUND

Some social-networking platforms permit marketers to target a particular audience of platform users for advertisements rather than all users of the platform. These social-networking platforms enable marketers to target this audience by selecting interaction data of the users, such as those that have “liked” a particular basketball player, to be presented with an advertisement for basketball shoes.

Marketers, however, are often unaware of which interaction data to select. By way of example, consider a marketer that selects to target, for an advertisement for a light-blue basketball shoe, users with interaction data indicating that they like or read articles by Dick Vitale because he is a well-known college basketball commentator. The marketer may not be aware that Dick Vitale is well-liked by fans of Duke University and often despised by fans of the University of North Carolina at Chapel Hill (“UNC”), which are rival teams, and also that the color of Duke University is dark blue and UNC is light blue. A fan of Duke University would not likely wear any shoes that are light blue, and thus would not only reject the advertisement but may also have animosity to the maker of that shoe. This is but one simple example of how a marketer's incomplete understanding of which interaction data to select can waste substantial advertising resources and even create negative impressions of a product or its manufacturer.

### SUMMARY

Techniques for using interaction data of application users to target a social-networking advertisement are described herein, as well as other techniques. Interaction data of application users is received through applications associated with the social-networking platform. This interaction data can provide additional information about users to better enable marketers to target users of a social-networking platform. This improved targeting potentially saves advertising resources, increases effectiveness of advertisements, or improves users' impressions of a maker or brand associated with the advertisement.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an environment in which interaction data of application users can be used to target a social-networking advertisement.

FIG. 2 illustrates the local computing device of FIG. 1 in detail.

FIG. 3 illustrates the marketing computing device of FIG. 1 in detail.

FIG. 4 is a flow diagram showing methods that use interaction data of application users to target a social-networking advertisement to a subset of a selected population of users of a social-networking platform.

FIG. 5 is a flow diagram showing methods that use interaction data of application users to target a social-networking advertisement for a product or service based on the social-networking application having a positive correlation to that product or service.

FIG. 6 is a flow diagram showing methods that use interaction data of application users to provide a selectable, expanded set of interaction data by which a set of users of a social-networking platform may be targeted.

FIG. 7 illustrates a selection interface with a selectable, expanded set of interaction data determined based on co-occurrences of interaction data.

FIG. 8 illustrates an example system usable to implement the techniques described herein.

### DETAILED DESCRIPTION

### Overview

This document describes various apparatuses and techniques for using interaction data of application users to target a social-networking advertisement. Various embodiments of these techniques receive interaction data from a social-networking application operating within a social-networking platform, correlate this interaction data of the social-networking application users with interaction data of other users of the social-networking platform, and provide this correlated interaction data to marketers effective to enable marketers to better target their advertisements.

For example, consider a social-networking application about college basketball. This application operates within a social-networking platform, such as the Facebook™ platform, Twitter™ platform, or LinkedIn™ platform. This basketball application has 10,000 users. Each of the users, on selecting to download and use this application, agrees to make available their interaction data and demographics to the application provider. Assume that this application receives interaction data from the users and that this data indicates that users that select a button to like Dick Vitale often also select a button to like Duke Basketball. Assume also that users that select a button to like UNC Basketball very rarely also select a button to like Dike Vitale. The techniques then determine that Dick Vitale and Duke Basketball are positively correlated for application users, and thus, by extension, platform users generally. The techniques may then use this positive correlation within the 10,000 application users to provide the Dick Vitale interaction data to a marketer when the marketer indicates that he wishes to advertise dark-blue (Duke Blue) basketball shoes to users of the social-networking platform. By so doing, the marketer may better target this advertisement to those platform users that are more likely to purchase dark-blue basketball shoes based on their liking Dick Vitale, thereby potentially saving resources, improving efficiency of the advertisement, or aiding the brand's reputation.

As noted in part above, a social-networking platform is a platform through which people, groups, and/or businesses interact, and that is capable of facilitating social-networking advertisements and social-networking applications. Thus, a platform may present, or be associated with, advertisements and applications that are presented to its users. These advertisements and applications are associated with the platform in one more numerous ways, such as being branded to that platform (e.g., a Facebook™-branded game), being accessible through the platform (even if interactions are actually managed by a third party), or presented within the platform's user interface (e.g., an advertisement for a resume-drafting service presented within the LinkedIn™ interface), to name but three examples. Social networking applications act and interact with users of the platform, while advertisements generally present information, though advertisements may allow some interactions, such as a button to select more information.

As will be discussed in greater detail below, interaction data may be explicitly selected or implicitly deduced from acts of a user with a platform, advertisement, or application. Examples include a user's explicit selection to “like” a music group in the Facebook™ platform or “follow” a person in the Twitter™ platform. These are examples of explicit acts by the user that indicate a user's interest through some selection mechanism, such through a button on the social-networking application or platform's user interface. Interaction data may also include a user's implicit interactions, such as to read a news article or buy a product.

Demographics are also discussed further below. Demographics include characteristics of persons, such as age, sex, ethnicity, country of origin, country of residence, and so forth. Populations can have, or be defined through, these characteristics, such as a population of a social-networking platform that are female, between 13 and 17 years of age, and reside in Christchurch, New Zealand.

The basketball example described above is only one way in which the techniques and apparatuses may be used, many others are contemplated herein. These techniques and/or apparatuses are referred to separately or in conjunction as the “techniques” as permitted by the context.

This document now turns to an example environment in which the techniques can be embodied, after which various example methods for performing the techniques are described. Example methods may be performed in the example environment as well as other environments. Consequently, performance of the example methods is not limited to the example environment and the example environment is not limited to performance of the example methods.

### Example Environment

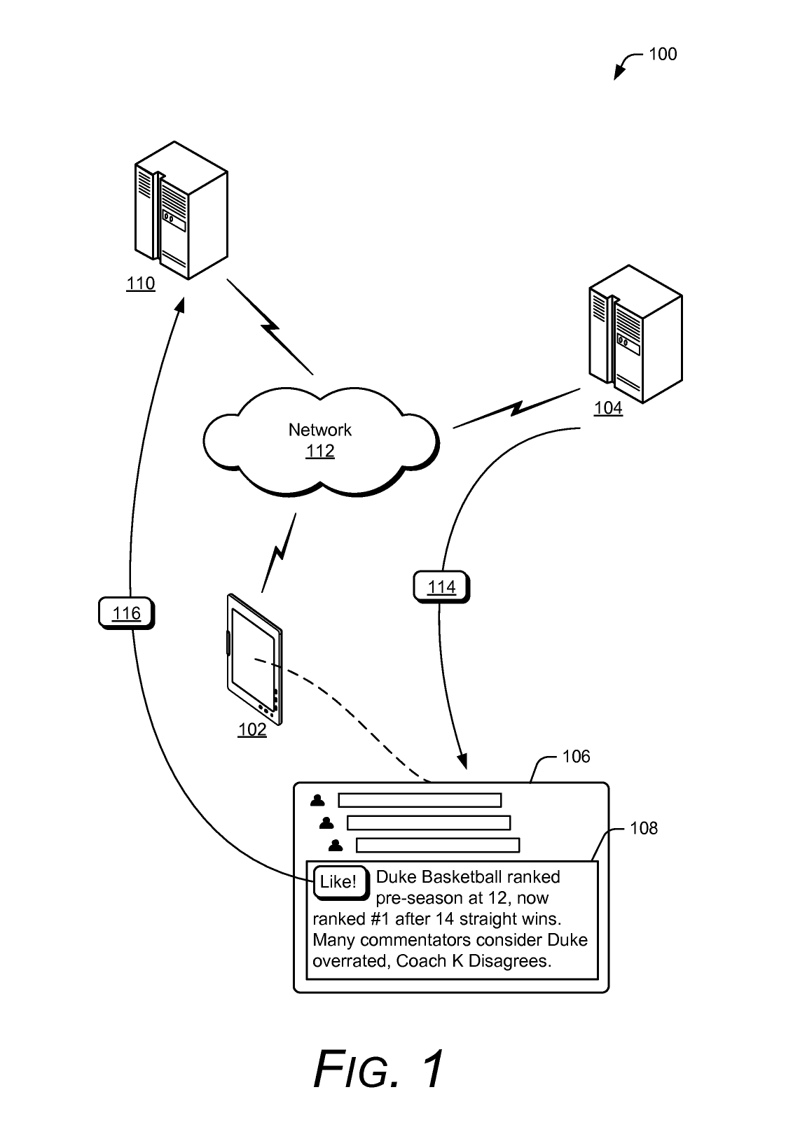

FIG. 1 illustrates an example environment 100 that is operable to employ techniques described herein. Environment 100 includes a local computing device 102, a platform computing device 104 that provides a social-networking platform 106 in which a social-networking application 108 may operate, a marketing computing device 110, and a network 112 through which the computing devices may communicate, each of which may be configured in a variety of ways.

Generally, platform computing device 104 provides social networking platform 106 for use by a user of local computing device 102, this provision shown at platform arrow 114. Also generally, a user's interactions with social-networking application 108, here shown with a selection to “Like!” a news article about Duke Basketball, are provided to marketing computing device 110, this provision shown at interaction data arrow 116.

Social-networking platform 106 enables interactions between users, such as people, resources (e.g., websites), and businesses. Applications, such as social-networking application 108, may operate within social-networking platform 106, though this operation may be provided by computing resources other than those of platform computing device 104. As noted in the above example, a user of a platform may select various social-networking applications, such as a college basketball news application, with which to interact through the platform. Thus, a user may select a social-networking application that presents news articles, interactive games, and videos about gourmet food, a social-networking application that presents basketball videos, blogs, and the latest news, a social-networking application that presents and enables a user to purchase designer shoes, or a social-networking application that teaches children math through simple video games, to name but a few.

Social-networking applications 108, either independently or in conjunction with social-networking platform 106, may receive interaction data. This interaction data may be explicitly selected or implicitly deduced from an act of the user. Examples include a user's explicit selection to “like” a music group, a topic (surfing), a basketball player, or a gourmet chef, or to “read” a news article about the Aztec civilization or global cooling, “view” a video, “listen” to a song, or “follow” a topic or person. These are explicit in that a user selects to indicate their interest or interaction through some selection mechanism, such through the social-networking application's user interface. Interaction data also includes a user's implicit interactions, such as to read a news article but not explicitly indicate that it is being read by the user, selection to download an application, selection to buy a product or service, or to interact with friends or professional colleagues, for example. Note that a single implicit or explicit selection of a user, and thus its corresponding interaction data, can substantially alter how that user is analyzed by the techniques, which affects whether that user receives or does not receive various advertisements, though this depends on the selection made.

Interaction data received through a social-networking application includes whatever interaction data the social-networking application records, passes to an external source, or is legally able to use. In some cases social-networking platform 106 does not permit interaction data received through a social-networking application operating within the platform to be used by an entity not associated with the social-networking application, often due to privacy concerns. This can substantially limit use of interaction data for marketing and other purposes, in some cases entirely, except in cases where the entity associated with the social-networking application that receives the interaction data also uses it for marketing. Thus, the social-networking application or an entity associated therewith can be permitted by the platform to use interaction data received through the social-networking application for marketing when the social-networking application or entity uses the interaction data for marketing rather than some other entity, such as in cases where the social-networking application or entity is governed by a confidentiality agreement permitting collection and use of the interaction data.

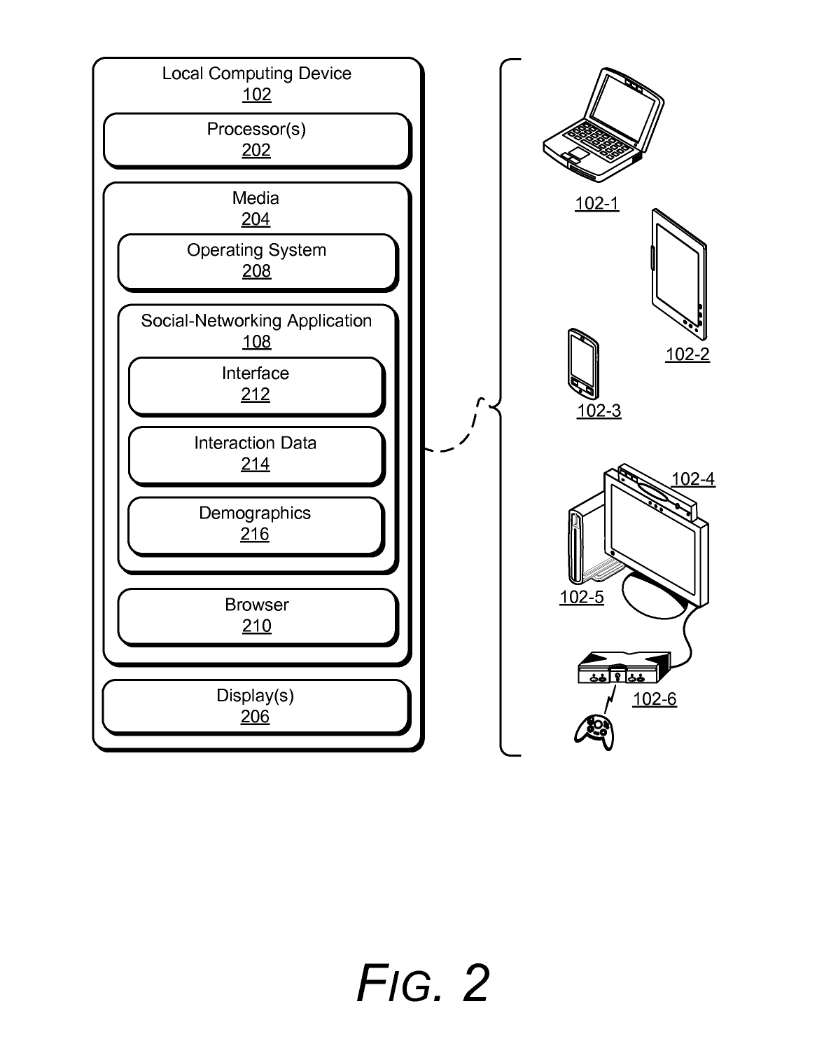

FIG. 2 illustrates an example embodiment of local computing device 102 of FIG. 1, which is illustrated with six examples devices: a laptop computer 102-1, a tablet computer 102-2, a smart phone 102-3, a set-top box 102-4, a desktop computer 102-5, and a gaming device 102-6, though other computing devices and systems, such as servers and netbooks, may also be used.

Local computing device 102 includes or has access to computer processor(s) 202, computer-readable storage media 204 (media 204), and one or more displays 206, four examples of which are illustrated in FIG. 2. Media 204 includes an operating system 208, social-networking application 108, and browser 210. Social-networking application 108 includes an interface 212 and includes, receives, passes, or stores interaction data 214 and demographics 216.

Social-networking platform 106 is shown presented by local computing device 102 in FIG. 1, such as through a user interface generated by platform computing device 104 and presented through browser 210 at local computing device 102, though various other manners are permitted by the techniques.

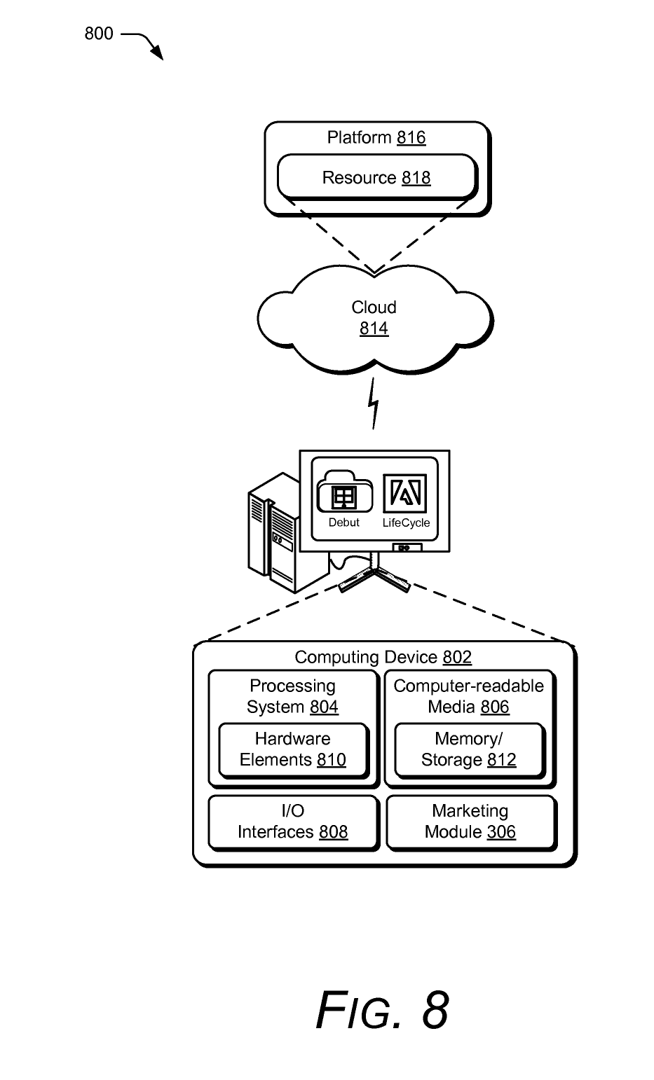

Local computing device 102 may be configured as a full resource device with substantial memory and processor resources (e.g., personal computers, game consoles), a mid-resource device with moderate memory and resources (e.g., a netbook), or a low-resource device with limited memory and/or processing resources (e.g., mobile devices, automobile computing devices, computers within children's toys, kitchen appliances with computing abilities). Local computing device 102 may be representative of one or a plurality of different devices, such as multiple servers utilized by a business to perform operations “over the cloud” as further described in relation to FIG. 8.

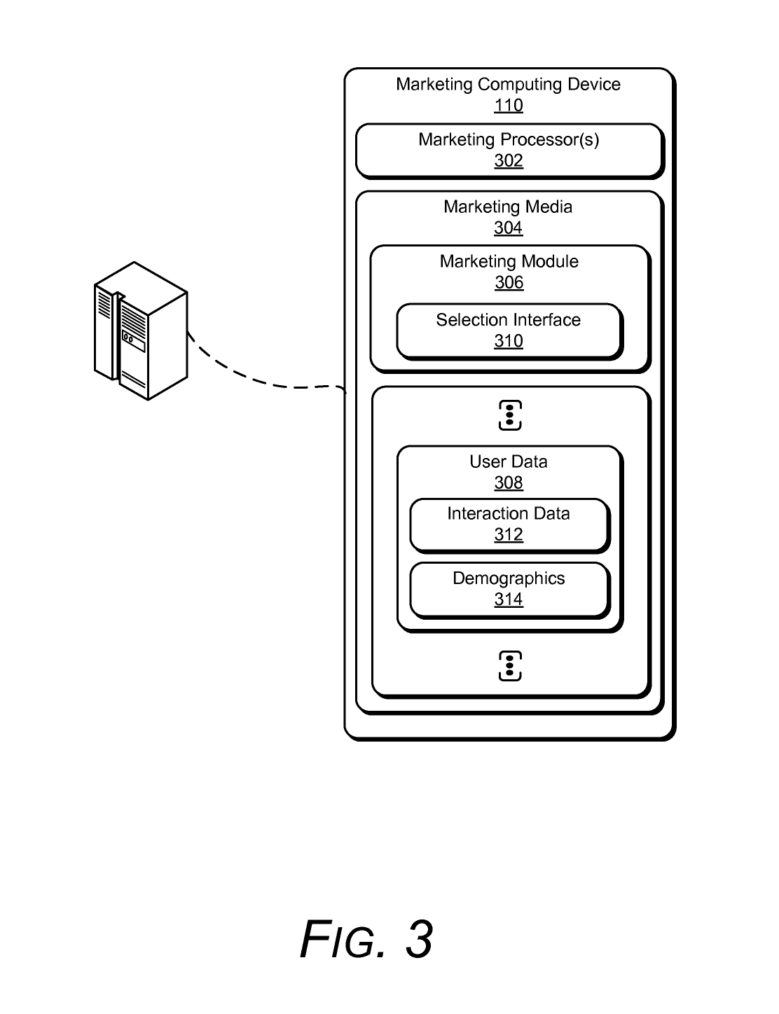

FIG. 3 illustrates an example embodiment of marketing computing device 110. Marketing computing device 110 is shown as a singular entity for visual brevity, though multiple devices may instead be used. Marketing computing device 110 includes or has to access to marketing processor(s) 302 and marketing computer-readable storage media 304 (marketing media 304). Marketing media 304 includes marketing module 306 and user data 308, generally of many users. Marketing module 306 includes a selection interface 310. User data 308 of each user (e.g., received through social-networking application 108 of FIGS. 1 and 2) includes interaction data 312 and demographics 314.

Marketing module 306 is capable of using interaction data 312 of application users to target advertisements, such as to some portion of a population of users of social-networking platform 106. In some embodiments, marketing module 306 uses selection interface 310 to enable a marketer to select interaction data of application users.

Ways in which entities and components of FIGS. 1-3 act and interact are set forth in greater detail below. The components illustrated for local computing device 102 and marketing computing device 110 can be separate or integrated and operate as part of a web platform as described in relation to FIG. 8, for example. Social-networking application 108, for instance, may operate through marketing computing device 110 or marketing module 306 through local computing device 102. Regardless of where implemented, marketing module 306 is representative of functionality that is configured to use interaction data of application users to target advertisements.

### Example Methods

The following discussion describes methods that use interaction data of application users to target a social-networking advertisement, which may be implemented utilizing the previously described devices. Aspects of each of the methods may be implemented in hardware, firmware, or software, or a combination thereof. The methods are shown as a set of blocks that specify operations performed by one or more devices and are not necessarily limited to the orders shown for performing the operations by the respective blocks. In portions of the following discussion, reference will be made to FIGS. 1-3.

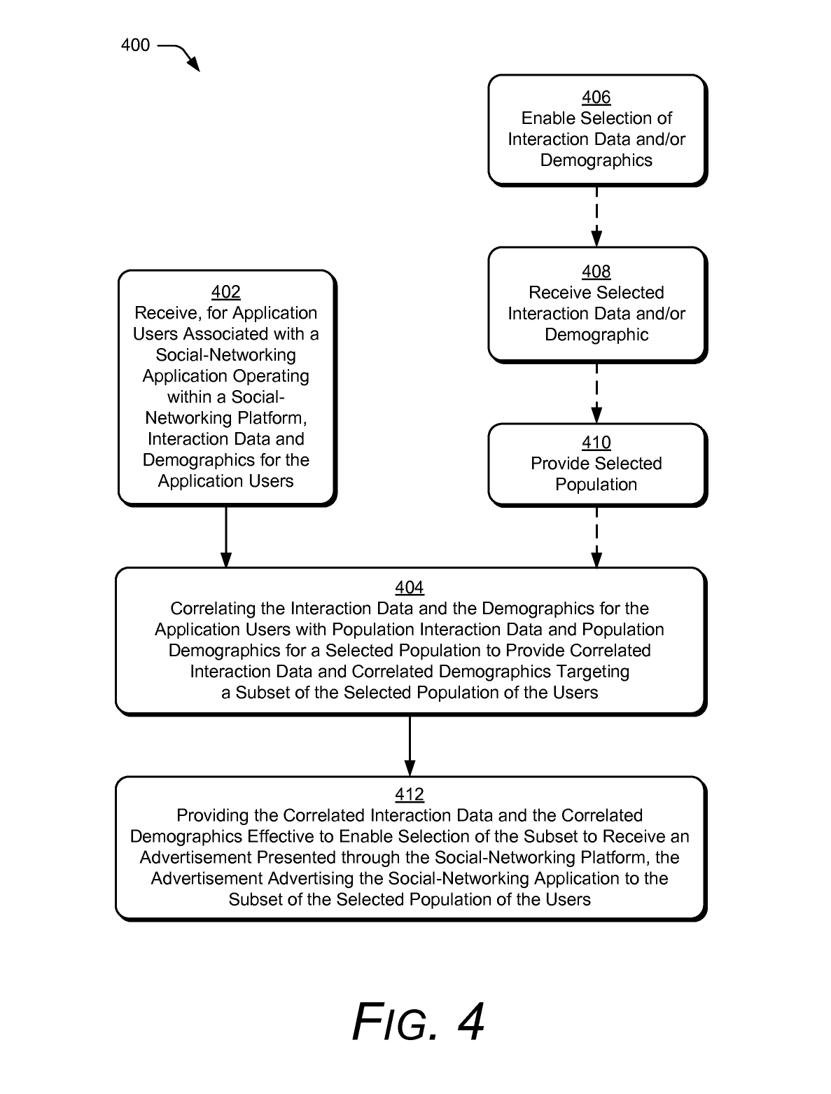

FIG. 4 depicts methods 400 in an example implementation in which the techniques use interaction data of application users to target a social-networking advertisement, including to a subset of a selected population of users of a social-networking platform.

Block 402 receives, of application users associated with a social-networking application operating within a social-networking platform, interaction data and demographics of the application users. By way of example, consider FIG. 1. Here a user may select to “Like!” or make some other action that is received, through social-networking application 108, as interaction data for that user. While not required, demographics of the application user can be received as well. Demographic data can be useful in correlating interaction data to relevant portions of a population of users of social-networking platform 106.

Block 404 correlates the interaction data and the demographics of the application users with population interaction data and population demographics of a selected population of users associated with the social-networking platform. By so doing, block 404 is able to provide correlated interaction data and correlated demographics targeting a subset of the selected population of the users. This selected population is some selected portion of a population associated with social-networking platform 106. In some cases, this portion is selected by a marketer through interaction data and/or demographics to narrow down the overall population. The interaction data and/or demographics used to narrow down the overall population can be determined through various external data to be statistically likely to be interested in the social-networking application, for example.

In more detail, block 404 may correlate the interaction data and demographics in various manners. For example, block 404 may establish interdependence of a selection made by multiple users, such as two users that select to follow a particular politician, which is determined to have high interdependence. Other examples of correlation include Pearson or rank-based methodologies, sometimes called correlation coefficients. Still other correlations include similarity measures, such as a cosine or a weighted cosine of vector-space representations of interaction data, angle or normalized angles derived from a cosine similarity, probability-based models, and chi-squared statistical models, as well as others. These example manners of correlating are not intended to limit application of the techniques.

This selected population may be received from various sources, external or internal to the techniques described herein, including as part of methods 400 through blocks 406, 408, and 410.

Block 406 enables selection of interaction data or demographics, block 408 receives selected interaction data and/or demographics, and block 410 provides a selected population based on the selections, the selected population being a portion of a population of users of the social-networking platform.

Block 412 provides the correlated interaction data and the correlated demographics effective to enable selection of the subset to receive an advertisement presented through the social-networking platform. This advertisement can advertise the social-networking application to the subset of the selected population of the users, though it may instead advertise products or services or simply present information.

By way of example, assume that the social-networking application from which the interaction data is received at block 402 is directed to clothing and shoes, including articles, user reviews, and purchasing options. Assume that a marketer has selected interaction data and demographics resulting in a selected population. Thus, the marketer, through sales and marketing analysis, has determined demographics and interaction data of those that are likely to be interested in this clothing and shoe application. The demographic is women, aged 24-58. The interaction data is based on this sales and marketing analysis and includes Glitz magazine, Jessica Simpson, and John Madden (the shoe designer, not the football coach).

The marketer may be presented with, and select interaction data and demographics at, blocks 406 and 408. Blocks 406 and 408 may be performed by the social-networking platform or by marketing module 306 through selection interface 310 of FIG. 3, such as a “like” or “read” of Glitz magazine, Jessica Simpson or Jessica Simpson Shoes, and John Madden Shoes and the demographic “Female, 24-58.” In so doing, the marketer narrows the overall population to the selected population, which is provided by block 410.

As noted, block 404 correlates interaction data and demographics of application users with the selected population's interaction data and demographics (Jessica Simpson, Female 24-58, and so forth). Assume that the interaction data of the application users received at 402 indicates the following interaction data of actual users of the application: Jessica Simpson, Nordy's, and Back-Joy Mattresses. Thus, assume that Nordy's and Back-Joy Mattresses positively correlate with Jessica Simpson. As Jessica Simpson is one of the interaction data of the selected population, both Nordy's and Back-Joy Mattresses can be presented and selected to further target the audience more narrowly than based on Glitz magazine, Jessica Simpson or Jessica Simpson Shoes, and John Madden Shoes. Note, however, that these techniques are not limited to using interaction data of application users based on correlating with other interaction data. In some cases interaction data of application users is used without reference to other interaction data, such as when used for initial targeting, e.g., as “seed” interaction data.

Block 412 provides this correlated interaction data (Nordy's and Back-Joy Mattresses), such as through a user interface to the marketer by which selected is enabled. Now that the marketer is aware of this correlated interaction data, the marketer may select these correlated interaction data effective to present the advertisement to a subset of the selected population of users. This subset can be more focused and successful, in many cases, thereby saving advertising costs.

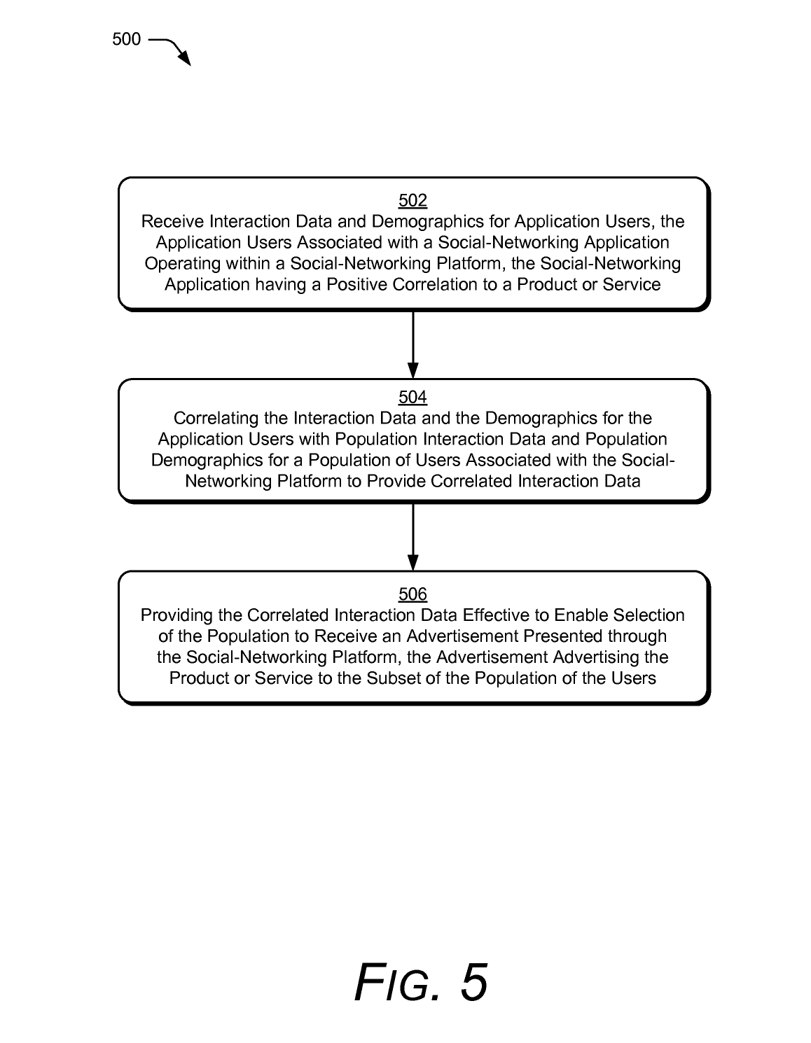

FIG. 5 depicts methods 500 in an example implementation in which the techniques use interaction data of application users to target a social-networking advertisement, including based on the social-networking application having a positive correlation to a product or service and for an advertisement advertising that product or service.

Block 502 receives interaction data and demographics of application users, the application users associated with a social-networking application operating within a social-networking platform, the social-networking application having a positive correlation to a product or service.

Block 504 correlates the interaction data and the demographics of the application users with population interaction data and population demographics of a population of users associated with the social-networking platform to provide correlated interaction data. This population of users can be all, a majority of, or some smaller subset of a total population associated with the social-networking platform. In some cases this correlation can be limited to those users of the population that have downloaded or otherwise interacted with the social-networking application from which the interaction data is received. In such a case, the interaction data of the population can be as little as using or even expressing interest in the application.

Block 504 may establish this positive correlation between the social-networking application and the product or service, though this is not required. In cases where block 504 establishes this positive correlation, block 504 may do so based on the social-networking application being associated with a marketing brand with which the product or service is also associated or is based on purchases of the product or the service by the application users associated with the social-networking application, to name but two examples.

Block 506 provides the correlated interaction data effective to enable selection of a subset of the population to receive an advertisement presented through the social-networking platform, the advertisement advertising the product or the service to the subset of the population of the users.

By way of example, assume that this advertisement is intended to sell models of classic cars from the 1950s to users of a social-networking platform. The interaction data received at block 502 is received through a social-networking application concerned with pictures and articles about classic cars. Thus, downloading and using this social-networking application indicates that users are more likely than an overall population to be interested in purchasing models of classic cars from the 1950s.

In the context of FIGS. 1-3, interaction data 214 and demographics 216 are received by social-networking application 108 presented at local computing device 102, and provided to marketing computing device 110 through network 112, shown at interaction data arrow 116. Assume that this interaction data 312 and demographics 314, shown in FIG. 3, are compiled from various interaction data 214 and demographics 216 of FIG. 2. Further, that this interaction data indicates that users of the application concerned with pictures and articles about classic cars often also enjoy Harley Davidson motorcycles, a particular fast-food diner chain (“Roaring 60s Diner”), Bass fishing, and New Zealand.

Also, assume for this example that external marketing data indicated that Harley Davidson motorcycles and the fast-food diner chain were known to be positively correlated to purchasing models of classic cars from the 1950s, but that Bass fishing and New Zealand were not known by the marketer. Further, while some external data may have indicated that marketing to those that like Harley Davidson motorcycles and this diner chain, this external data is not necessarily needed, as the application may provide sufficient information for a marketer to select a subset of the population for the advertisement. Further still, the interaction data received from this social-networking application indicated a positive correlation unknown to the marketer, namely Bass fishing and New Zealand. Concluding this example, assume that marketing module 306 of FIG. 3 enables selection of these four interaction data through selection interface 310, thereby enabling the marketer to advertise to a population with interaction data indicating that they like Harley Davidson motorcycles, the Roaring 60s Diner, Bass fishing, and/or New Zealand in some combination.

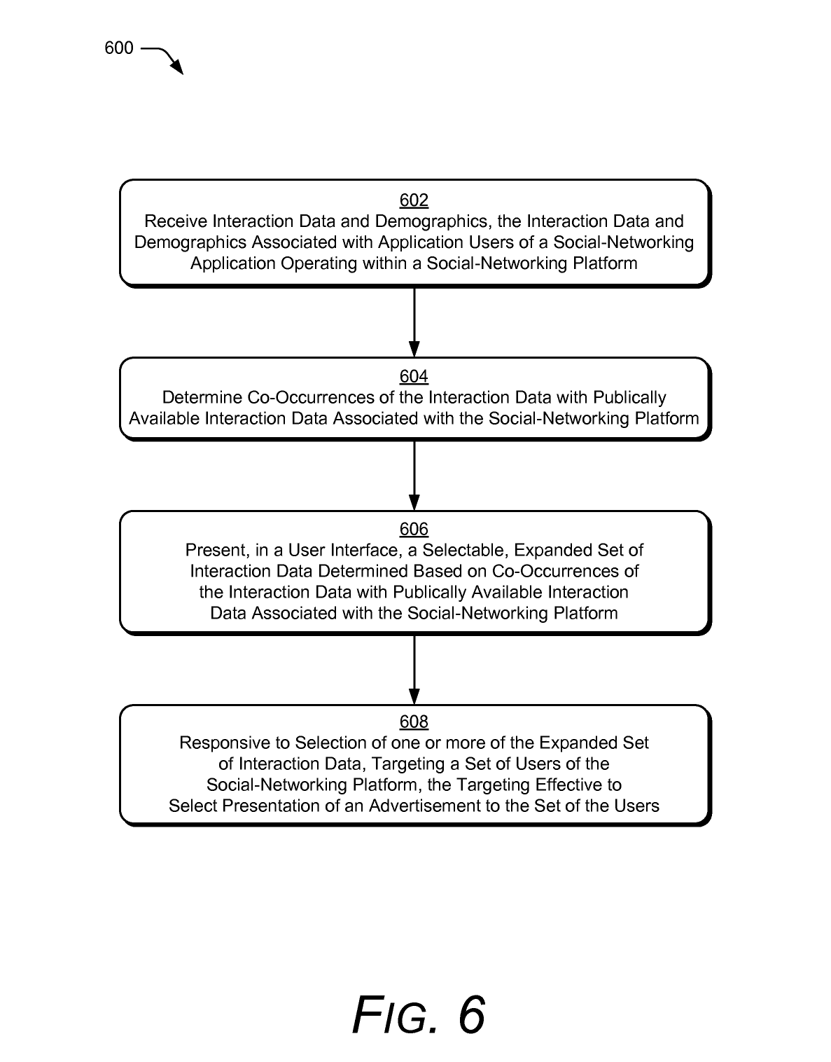

FIG. 6 depicts methods 600 in an example implementation in which the techniques use interaction data of application users to provide a selectable, expanded set of interaction data by which a set of users of a social-networking platform may be targeted.

Block 602 receives interaction data and demographics, the interaction data and demographics associated with application users of a social-networking application operating within a social-networking platform. Examples of these interaction data and demographics are set forth above.

While not required, the interaction data and demographics can be correlated, prior to block 604, with interaction data and demographics of an already selected population. Thus, a marketer may select to narrow the overall population to a selected population using interaction data and demographics (e.g., based on external data other than data received through the application) prior to block 604.

Block 604 determines co-occurrences of the interaction data with publically available interaction data associated with the social-networking platform. This publically available interaction data may be all or some set of interaction data, such as a set of interaction data and demographics selected by a marketer previously, though co-occurrences may be determined prior to receiving a selected set.

Block 606 presents, in a user interface, a selectable, expanded set of interaction data determined based on co-occurrences of the interaction data with publically available interaction data associated with users of the social-networking platform. In the above example, this publically available interaction data may be associated with users in the selected population rather than all users of the platform.

Block 608, responsive to selection of one or more of the expanded set of interaction data, targets a set of the users of the social-networking platform, the targeting effective to select presentation of an advertisement to the set of the users.

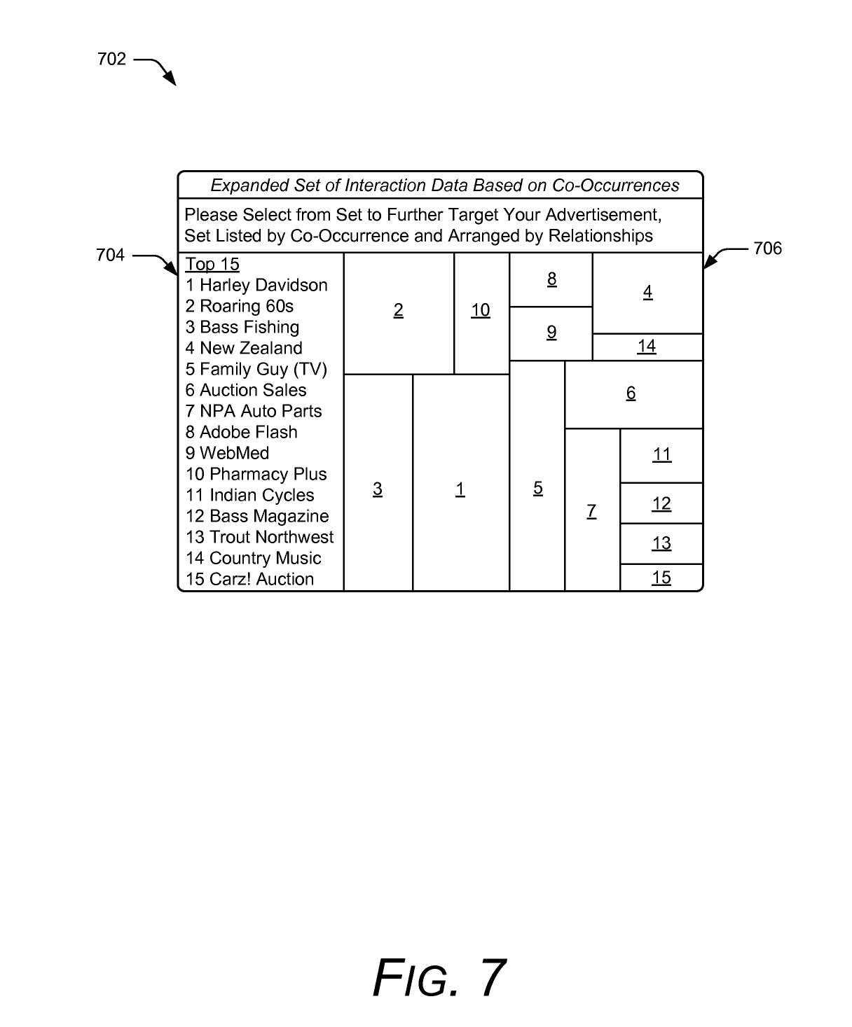

By way of example, consider interface 702 of FIG. 7, which is one example of selection interface 310 of FIG. 3. Interface 702 presents a selectable, expanded set of interaction data 704 determined based on co-occurrences of interaction data from the application concerned with pictures and articles about classic cars and previously selected interaction data of the social-networking platform generally. Thus, assume that a marketer determined, based on external data, a demographic of: males, aged 60+, and three interaction data: AARP (American Association of Retired Persons), Hot Rod Magazine, and The Beach Boys are likely to be interested in the buying models of classic cars of the 1950s.

Continuing the example, marketing module 306 receives interaction data and demographics for this social-networking application and also the selected demographic (males, aged 60+) and the three interaction data, and then determines co-occurrences between these demographics and interaction data and that of the demographics and interaction data received through the social-networking application. These co-occurrences are illustrated in FIG. 7, shown in a list format at selectable, expanded set of interaction data 704 and in a selectable graphic format 706. Note that the size of each of the rectangles can be proportional to the interaction data's strength of co-occurrence, thus, the largest is Harley Davidson (shown at number 1) and the smallest is the Carz! Auction (shown at number 15). Further, selectable graphic format 706 shows relationships between interaction data of the expanded set. Family Guy (TV) correlates more closely to its neighboring interaction data of 1, 10, 9, 6, and 7 than other correlation data shown. This can be useful in graphically illustrating interrelationships between interaction data.

In more detail, Family Guy (TV) correlates with Harley Davidson, Pharmacy Plus, WebMed, Auction Sales, and NPA Auto Parts more closely than it does to the graphically distant Roaring 60s, and Carz! Auction, for example. While not required, these correlations can aid a marketer in deciding which of these interaction data to select. A marketer that knows, from external data, that Trout Northwest is not as valuable a correlation due to the marketer's intention to sell mostly to the mid-Atlantic region and so may forgo using Trout Northwest and may down-weight or forgo using the neighboring NPA Auto Parts (number 7), and Carz! Auction (number 15).

Here assume that the marketer selects four of the expanded list, thereby having the following: Harley Davidson, Roaring 60s, Bass Magazine, and New Zealand, as well as the previously selected AARP, Hot Rod Magazine, and The Beach Boys, all for the demographic of males, aged 60+. With these selections, marketing module 306 targets the set of users for an advertisement to sell models of classic cars of the 1950s.

While this example concerns advertising for a product or service, other advertisements, such as those for a social-networking application (from which the interaction data is received or otherwise) or advertisements simply presenting information (e.g., public relations presentations) may also or instead be used.

### Example System and Device

FIG. 8 illustrates an example system generally at 800 that includes an example computing device 802 that is representative of one or more computing systems and/or devices that may implement the various techniques described herein. This is illustrated through inclusion of marketing module 306, which may be configured to use interaction data of application users to target a social-networking advertisement. Computing device 802 may be, for example, a server of a service provider, a device associated with a client (e.g., a client device), an on-chip system, and/or any other suitable computing device or computing system.

Computing device 802 as illustrated includes a processing system 804, one or more computer-readable media 806, and one or more I/O interface 808 that are communicatively coupled, one to another. Although not shown, computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

Processing system 804 is representative of functionality to perform one or more operations using hardware. Accordingly, processing system 804 is illustrated as including hardware element 810 that may be configured as processors, functional blocks, and so forth. This may include implementation in hardware as an application-specific integrated circuit or other logic device formed using one or more semiconductors. Hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

Computer-readable storage media 806 is illustrated as including memory/storage 812. Memory/storage 812 represents memory/storage capacity associated with one or more computer-readable media. Memory/storage 812 may include volatile media (such as random access memory (RAM)) and/or nonvolatile media (such as read only memory (ROM), Flash memory, optical disks, magnetic disks, and so forth). Memory/storage 812 may include fixed media (e.g., RAM, ROM, a fixed hard drive, and so on) as well as removable media (e.g., Flash memory, a removable hard drive, an optical disc, and so forth). Computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. Computing device 802 may be configured to implement particular instructions and/or functions corresponding to the software and/or hardware modules. Accordingly, implementation of a module that is executable by computing device 802 as software may be achieved at least partially in hardware, e.g., through use of computer-readable storage media and/or hardware elements 810 of processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of computing device 802 and are not limited to the specific examples of the techniques described herein. This functionality may also be implemented all or in part through use of a distributed system, such as over a “cloud” 814 via a platform 816 as described below.

Cloud 814 includes and/or is representative of platform 816 for resources 818. Platform 816 abstracts underlying functionality of hardware (e.g., servers) and software resources of cloud 814. Resources 818 may include applications and/or data that can be utilized while computer processing is executed on servers that are remote from computing device 802. Resources 818 can also include services provided over the Internet and/or through a subscriber network, such as a cellular or Wi-Fi network.

Platform 816 may abstract resources and functions to connect computing device 802 with other computing devices. Platform 816 may also serve to abstract scaling of resources to provide a corresponding level of scale to encountered demand for resources 818 that are implemented via platform 816. Accordingly, in an interconnected device embodiment, implementation of functionality described herein may be distributed throughout system 800. For example, the functionality may be implemented in part on computing device 802 as well as via platform 816 that abstracts the functionality of cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving interaction data and demographics of application users, the application users associated with a social-networking application operating within a social-networking platform, the social-networking application having a positive correlation to a product or service;
correlating the interaction data and the demographics of the application users with population interaction data and population demographics of a population of users associated with the social-networking platform to provide correlated interaction data; and
providing the correlated interaction data effective to enable selection of a subset of the population to receive an advertisement presented through the social-networking platform, the advertisement advertising the product or the service to the subset of the population of the users.

2. A method as described in claim 1, wherein the population of users is selected prior to correlating the interaction data and the demographics.

3. A method as described in claim 2, wherein the population is selected responsive to determining that the selected population is statistically likely to be interested in the product or service.

4. A method as described in claim 1, wherein the population of users includes a majority of a total population associated with the social-networking platform.

5. A method as described in claim 1, further comprising establishing the positive correlation between the social-networking application and the product or service.

6. A method as described in claim 5, wherein establishing the positive correlation is based on the social-networking application being associated with a marketing brand with which the product or service is also associated.

7. A method as described in claim 5, wherein establishing the positive correlation is based on purchases of the product or the service by the application users through the social-networking application.

8. A method as described in claim 1, wherein the social-networking application or an entity associated therewith is governed by a confidentiality agreement permitting collection and use of the interaction data and the demographics of the application users.

9. A method as described in claim 1, wherein the interaction data includes actions or selections performed by the application users through the social-networking application.

10. One or more computer-readable storage media comprising instructions that are stored thereon that, responsive to execution by a computing device, causes the computing device to perform operations comprising:
receiving interaction data, the interaction data associated with application users of a social-networking application operating within a social-networking platform;
determining co-occurrences of the interaction data with publically available interaction data associated with users of the social-networking platform;
presenting, in a user interface, a selectable, expanded set of interaction data determined based on the co-occurrences; and
responsive to selection of one or more of the expanded set of interaction data, targeting a set of the users of the social-networking platform, the targeting effective to select presentation of an advertisement to the set of the users.

11. One or more computer-readable storage media as described in claim 10, wherein the advertisement advertises the social-networking application.

12. One or more computer-readable storage media as described in claim 10, wherein the advertisement advertises a product or service.

13. One or more computer-readable storage media as described in claim 10, wherein receiving the interaction data is from a remote entity contractually associated with a local entity performing the operations, the contractual association permitting use of the interaction data of the application users.

14. A method comprising:
receiving interaction data and demographics of application users, the application users associated with a social-networking application operating within a social-networking platform;
correlating the interaction data and the demographics of the application users with population interaction data and population demographics of a selected population of users associated with the social-networking platform to provide correlated interaction data and correlated demographics, the correlated interaction data and correlated demographics targeting a subset of the selected population of the users; and
providing the correlated interaction data and the correlated demographics effective to enable selection of the subset to receive an advertisement presented through the social-networking platform, the advertisement advertising the social-networking application to the subset of the selected population of the users.

15. A method as described in claim 14, wherein the selected population is determined to be statistically likely to be interested in the social-networking application based on external data, the external data external to the social-networking platform.

16. A method as described in claim 14, wherein the interaction data includes actions or selections performed by the application users through the social-networking application.

17. A method as described in claim 14, wherein the interaction data and the population interaction data include one or more of the following actions: “like” an object; “read” an article or book; “listen” to a song; or “view” a video.

18. A method as described in claim 14, wherein the social-networking application or an entity associated therewith is governed by a confidentiality agreement permitting collection and use of the interaction data and the demographics.

19. A method as described in claim 14, further comprising:
enabling selection of selectable interaction data or selectable demographics;
receiving selected interaction data or selected demographics; and
providing the selected population, the selected population selected based on the selected interaction data or the selected demographics.

20. A method as described in claim 14, wherein providing the correlated interaction data and the correlated demographics enables selection, through a user interface, of the correlated interaction data and the correlated demographics to select the subset of the selected population of the users.
